(19) United States
(12) Patent Application Publication
(10) Pub. No.: US 2021/0267161 A1
(43) Pub. Date: Sep. 2, 2021

(54) A Pasture Demarcation System for Grazing Animals

(71) Applicant: Grazebot Limited, Collinstown, Co. Westmeath (IE)

(72) Inventors: Thomas Drumm, Collinstown (IE); James Drumm, Collinstown (IE); Charlie Drumm, Collinstown (IE)

(21) Appl. No.: 17/274,001

(22) PCT Filed: Sep. 3, 2019
(86) PCT No.: PCT/EP2019/073432

§ 371 Date: Mar. 5, 2021

(30) Foreign Application Priority Data
Sep. 5, 2018 (IE) 2018/0295

(51) Int. Cl. A01K 3/00

(52) U.S. Cl. CPC A01K 3/005

(57) ABSTRACT

The present application provides a pasture demarcation system for grazing animals in which demarcation vehicles are provided which move along the wire of an electric fence without requiring additional support and as such may be used with a conventional electric fence with minimal changes.

### TECHNICAL FIELD

The present application relates to a demarcation system for limiting the freedom of grazing animals and more particularly to a movable pasture demarcation system and provides a several different components which are useful in the provision of such a demarcation system.

### BACKGROUND

It is generally advantageous to be able to manage the areas in which animals, for example cows, sheep or goats, graze. More specifically, it allows for a more efficient use of land and control of the animals feeding. Such techniques are generally referred to as strip grazing.

In certain farms this may be achieved by using a demarcating element to demarcate a pasture into different areas and moving the animals between areas as required.

A wire fence, which may be electrified, is a common demarcating element.

At the same time, it is known to have a movable demarcating element.

In particular, systems using tumble wheels (also known as spider wheels) allow a fence to be moved quickly by a single person. Tumble wheels are a wire fence which have a central guide through which a fence wire may be placed or a connector place centrally on either side for engaging with a fence wire. A number of lightweight spokes extend radially from the centre outwards. Typically, there are 6 spokes of which any two normally rest on the ground supporting the fence wire. If a person moves an end of the fence wire, it urges the centre of the tumble wheel forward causing the tumble wheel to rotate lifting one of the spokes off the ground and as it progresses causing a subsequent spoke to contact the ground.

It is beneficial if such systems can be automated as it allows for greater control and reduces labour.

A number of automated demarcation systems are known, in which a demarcating element is connected between a first vehicle and another point which might be a second vehicle.

In one approach, the vehicles run along the ground and are provided with a tracking arm structure for making it possible to track along a guide element which may be other wire fencing. The vehicles are however heavy and can be unreliable on rough terrain or in wet conditions. A further problem is that as the demarcation element is desirable at a height significantly higher than the vehicle body, a pull on the demarcation element can topple these vehicles.

A device of this type is described in DE 42 15 714. US20070018602 is a similar approach but reduces the risk of undue strain being placed on the wire fencing. However, such vehicles are expensive and can be unreliable depending on the terrain.

Another approach is to provide a system where the vehicles are like cable cars moving along a fence. These systems require additional wire to provide power and to support the vehicles. A further known device is described in DE2144587A1 which provides a pulley wheel moving along a wire.

A further device is known from U.S. Pat. No. 6,062,165 which discloses a farming system comprising a circular plot of land. Electric fences defining a wedge shaped paddock may be moved around the circular plot.

Another approach is to limit the grazing of animals by providing a transponder around their neck. In this approach, a GPS sensor is used to identify the position of the animal and to ensure it is inside its associated grazing area. If the animal moves outside its grazing area, they receive an electric shock. Whilst this eliminates the need for fencing, it raises animal husbandry issues. At the same time, it is of limited use for controlled grazing as it provides no visual indicator to the animals of where they should be grazing. Whilst solutions are known including using a sound device to warn when the animal is moving toward the boundary of their allowed grazing area. Similarly lighting devices could be employed to indicate to an animal where a grazing area is. The nature of these systems remains less than ideal for controlled grazing of animals.

The present application provides an overall system which addresses the above deficiencies and others in the art. It provides a number of innovative features which are in each useful in their own right but which equally may be combined together in various combinations to advantage.

### SUMMARY

Accordingly, a first aspect of the present application provides a device for moving along a first demarcation element in a pasture. The device which may be described as a demarcation vehicle comprises a first wheel for engaging with and being movable along a longitudinal axis of the first demarcation element. An actuator is provided for causing rotation of the first wheel to cause the device to move along the first demarcation element. A body is connected to and supported by the first wheel, where the body and first wheel are free to rotate together about the longitudinal axis of the first demarcation element. A receiver is coupled to the body and provided on the opposite side of the longitudinal axis to the first wheel, the receiver being configured to receive an end of a second demarcation element. The advantage of this approach is that tension in the second demarcation element prevents the body and wheel rotating about the first demarcation element meaning that no other support other than the first demarcation element is required for the device. This means that it can be deployed on a conventional demarcation element and in particular on conventional electric fences.

The first wheel may be substantially co-planar with the point where the receiver receives the end of the first demarcation element. The actuator may be an electric motor and in particular a DC motor.

Suitably, the device has an on-board power supply for powering the electric motor. This power supply may be a battery, which in turn may be re-chargeable.

The tensile force exerted by the second demarcation element upon the receiver limits rotation of the body and guide wheel about the longitudinal axis of the first demarcation element.

The inner peripheral surface of the first wheel is suitably shaped to receive and grip the first demarcation element. Thus, the inner peripheral surface may define a channel having two side walls for receiving the first demarcation element. These side walls may taper inwards toward the centre of the wheel to provide a friction fit with the first demarcation element. The angle of this taper (β) may be in the range of between 2 and 7 degrees and suitably is about 4 degrees.

At the same time, an outer peripheral surface may be provided which is shaped to receive and pass along an insulator present on the first demarcation element.

A second wheel may be coupled to the body and positioned to be aligned with the first wheel along the longitudinal axis so as to be movable along the first demarcation element at the same time as the first wheel. Having a second wheel provides a more stable platform.

The second wheel may be mechanically coupled to an actuator for causing the second wheel to rotate to effect movement of the second wheel along the wire of the fence. This may be the same actuator as that driving the first wheel. By driving both wheels, the ability of the device to pass over insulators is improved.

A drive belt or chain may be employed to connect the motion of the first and second wheels.

The first and second wheels may be the same size and shape.

A guide wheel may be provided which is positioned on the opposite side of the longitudinal axis to the first wheel wherein the guide wheel acts to prevent movement of the device in a direction transverse to the longitudinal axis toward the first wheel.

This guide wheel may be free to move relative to the body in a direction transverse to the longitudinal axis but with a resilient bias toward the longitudinal axis.

The device is intended to work with demarcation elements having a diameter in the range of 1 mm to 10 mm and more specifically in the range of 2 mmmm to 4 mm. The device has performed well where the diameter of the first demarcation element, being a high tensile wire, is about 2.5 mm.

To operate satisfactorily, the device should be relatively lightweight, suitably less than 10 kg. More suitably, the weight of the device is less than 4 kg and preferably less than 2.5 kg. In one arrangement, the receiver is an attachment feature for directly connecting to the end of a demarcation element.

In another, the receiver comprises a reel provided on the body and having a drum around which the end of a second demarcation element may be wound. In which case, the device may further comprise an actuator for causing the reel to wind the drum.

This actuator may be a torsional spring or a motor.

A sensing arrangement may be provided for sensing the tension in the second demarcation element. With such a sensing arrangement, the device may be configured to respond to the sensed tension to operate the motor to cause the second demarcation element to be payed out from or retrieved onto the reel to maintain the tension of the second demarcation element within a pre-determined range.

The reel may be provided on an arm and is free to move relative to the body in a direction transverse to the longitudinal axis and is resiliently biased toward the body.

The sensing arrangement may comprise a first switch for detecting the presence of the reel at a first position relative to the body and may further comprise a second switch for detecting a second position of the reel relative to the body.

Alternatively, the sensing arrangement may comprise a linear position sensor for measuring the relative distance between the reel and body.

Suitably, a controller is provided for operating the device with the controller being provided on-board the device.

The controller may be configured to determine a position for the device along the first demarcation element.

The controller may be configured to receive a first position at the time the device is provided onto the first demarcation element and configured to store this position as the current device position. This first position may be entered by a user on an input device or provided by a GPS device.

The device may further comprise an encoder for providing a measure of distance moved along the first demarcation element, wherein the first position is updated by the measure of distance moved to provide a current position for the device along the first demarcation element.

The device may further comprise a post detector for detecting a post along the first demarcation element and for updating the current position of the device based on a previously stored position for the post. This post detector may be configured to individually identify posts, for example using RFID or other machine-readable post identifier provided on the post.

The controller may be configured to operate the motor so that the device moves in discrete steps rather than on a continuous basis.

The step size may be in the range of 5 cm to 1 m and suitably is in the range 15 cm to 60 cm. More advantageously, the step size is selected to be in the range of 20 cm to 40 cm.

The device may have a communications device and the controller may be configured to communicate using said communications device. In which case, the controller may be configured to receive a schedule for operation of the device via the communications device. Suitably, the schedule details the required movements of the device over a forthcoming time period.

The communications device is suitably a wireless device.

The device may be configured to communicate with an electric fence controller over the single demarcation element, whereby the device may be configured to send a signal to cause the electric fence controller to reduce or increase the voltage outputted by the electric fence controller or to send a signal to turn-on or turn off the voltage outputted by the electric fence controller. A signal may be sent prior to the device moving and a separate signal is sent after the device has stopped.

Advantageously, by insulating the attachment point for the demarcation element from the demarcation element the vehicle is moving along, a switchable connection may be provided for. This allows the selective activation or de-activation of the demarcation element being moved instead of the entire demarcation system. It also allows for the local control of this on the demarcation vehicle, e.g. when the motor is operating. The device may further comprise a camera, wherein the camera is positioned to capture an image of the pasture from the device along the second demarcation element. This camera may be mounted underneath or on top of the device. Suitably, it is positioned on the arm of the device. The controller may be connected to the camera and configured to upload images captured by the camera using the communications device.

In a further aspect, a support for a wire of an electric fence is provided. The support comprises a tubular guide for receiving the wire of the electric fence;
a mounting feature for mounting the support to a fence post, an arm extending between the tubular guide and the mounting feature so that the tubular guide is raised above the fence post when the support is mounted on the fence post.

In another aspect, a control system is provided for a movable electric fence, the control system being operable to:

cause a motor to operate to move the electric fence; and
to at least reduce the power to the electric fence when the motor is operating.

In another aspect, a control system for a movable electric fence is provided with the control system being operable to:

cause a motor to operate to move the electric fence; and
having a sensor for detecting when an electric discharge occurs from the electric fence, wherein the control system is configured to at least reduce the power to the electric fence when the motor is operating and the sensor detects an electric discharge.

The motor of the preceding aspects may be a motor in a demarcation vehicle or a motor in a gate for a demarcation system.

The application also provides a method of improving the positioning of a device moving along a wire fence where the wire fence is supported by vertical posts comprising the steps of: acquiring a first position using a global positioning system to identify the position of the device with a first accuracy,

detecting the presence of a vertical post,
checking for the pre-stored position of the vertical post,
refining the first position based on the detection of the vertical post, and updating the position of the device using a measure of distance travelled along the wire fence by the device.

In a further aspect, a gate is provided for a fence. This gate comprises:

a base; a guide for guiding the wire of a fence; a vertical support extending between the guide and the base, wherein the vertical support is extendible between a first position and a second position relative to the base; a communication device for receiving a control signal from a controller to operate the gate; an actuator for moving the vertical support between the first and second positions in response to receipt of the control signal.

The gate may further comprise a GPS device for determining the position of the gate and for providing this through the communications device to the controller.

The gate may further comprise a sensor for confirming the actuation of the gate.

In another aspect, the present application provides a system for a movable paddock within a pasture; the system comprising:

a first demarcation element and a second demarcation element which define opposite first and second sides of the paddock; a movable demarcation element defining a side of the paddock transverse to and extending between the first and second sides of the paddock;
a local controller provided on the movable demarcation element for controlling the movement of the demarcation element, the local controller having a positioning system for determining a position of the movable demarcation element along one of the first or second demarcation elements, the local controller having a communications device for establishing a data connection with a remote controller,
the remote controller providing the user with a graphical user interface presenting the user with a graphical representation of the pasture and indicating the position of the movable wire fence in the pasture and including an indication of the position of the movable fence at future times, the remote controller providing the user with an input allowing the user to alter the times or positions indicated, the remote controller being configured in response to this input to send a signal to the local controller, the local controller being responsive to the signal and adjusting the speed of movement of the movable demarcation element.

In another aspect, a system is provided for demarcating an area within a pasture; the system comprising a first demarcation element and a second demarcating element which define opposite first and second sides of the area; a first demarcation vehicle provided at a first side and movable along the first side, a second demarcation vehicle provided at the second side and movable along the second side, a first movable demarcation element extending between the first and second vehicles, the first movable demarcating element defining a third side of the area; a third vehicle provided at a first side and movable along the first side, a fourth vehicle provided at the second side and movable along the second side, a second movable demarcation element extending between the third and fourth vehicles, the second movable demarcation element defining a fourth side of the area; a control system for controlling the movement of each of the vehicles, wherein the control system is operable to adjust the individual position of each of the four vehicles to perform at least one of: moving the area within the pasture; altering the size of the area; and altering the shape of the area.

The application should be taken to extend to and include the following series of numbered statements.
1. A device for moving along a first demarcation element in a pasture, the device comprising:
   a first wheel for engaging with and being movable along a longitudinal axis of the first demarcation element;
   an actuator for causing rotation of the first wheel to cause the device to move along the first demarcation element;
   a body connected to and supported by the first wheel, where the body and first wheel are free to rotate about the longitudinal axis of the first demarcation element;
   a receiver coupled to the body and provided on the opposite side of the longitudinal axis to the first wheel, the receiver being configured to receive an end of a second demarcation element.
2. A device according statement 1, wherein the wheel is substantially co-planar with the point where the receiver receives the end of the first demarcation element.
3. A device according to any preceding statement, wherein the actuator is an electric motor.
4. A device according to statement 3, further comprising a power supply for powering the electric motor.
5. A device according to statement 4, wherein the power supply is a battery.
6. A device according to any preceding statement, wherein the tensile force exerted by the second demarcation element upon the receiver limits rotation of the body and guide wheel about the longitudinal axis of the first demarcation element.
7. A device according to any preceding statement, wherein an inner peripheral surface of the first wheel is shaped to receive and grip the first demarcation element.
8. A device according to statement 7, wherein the inner peripheral surface defines a channel having two side walls for receiving the first demarcation element.
9. A device according to statement 8, wherein the side walls taper inwards toward the centre of the wheel to provide a friction fit with the first demarcation element.
10. A device according to statement 9, wherein the angle of the taper (β) is in the range of between 2 and 7 degrees.
11. A device according to statement 10, wherein the angle of taper is about 4 degrees.
12. A device according to any one of statements 7 to 11, further comprising an outer peripheral surface, wherein the outer peripheral surface is shaped to receive and pass along an insulator on the first demarcation element.
13. A device according to any preceding statement, further comprising a second wheel coupled to body and positioned to be aligned with the first wheel along the longitudinal axis so as to be movable along the first demarcation element at the same time as the first wheel.
14. A device according to statement 13, wherein the second wheel is mechanically coupled to an actuator for causing the second wheel to rotate to effect movement of the second wheel along the wire of the fence.
15. A device according to statement 14, wherein there is a single actuator for causing rotation of the first and second wheels.
16. A device according statement 15, wherein a drive belt or chain connects the first and second wheels.
17. A device according to any one of statements 13 to 16, wherein the first and second wheels are the same size and shape.
18. A device according to any preceding statement, further comprising a guide wheel which is positioned on the opposite side of the longitudinal axis to the first wheel wherein the guide wheel acts to prevent movement of the device in a direction transverse to the longitudinal axis toward the first wheel.
19. A device according to statement 13, wherein the guide wheel is free to move relative to the body in a direction transverse to the longitudinal axis and is resiliently biased toward the longitudinal axis.
20. A device according to any preceding statement, wherein the device is configured for use where the first demarcation element has a diameter in the range of 1 mm to 10 mm.
21. A device according to statement 20, wherein the device is configured for use where the first demarcation element has a diameter in the range of 2 mmmm to 4 mm.
22. A device according to statement 21, wherein the diameter of the first demarcation element is about 2.5 mm.
23. A device according to any preceding device, wherein the weight of the device is less than 10 kg.
24. A device according to statement 23, wherein the weight of the device is less than 4 kg and preferably less than 2.5 kg.
25. A device according to any preceding statement, wherein the receiver is an attachment feature for directly connecting to the end of a demarcation element.
26. A device according to any one of statements 1 to 24, wherein the receiver comprises a reel provided on the body and having a drum around which the end of a second demarcation element may be wound.
27. A device according to statement 26, wherein further comprising an actuator for causing the reel to wind the drum.
28. A device according to statement 27, wherein the actuator comprises a torsional spring.
29. A device according to statement 28, wherein the actuator comprises a motor.
30. A device according to statement 29, further comprising a sensing arrangement for sensing the tension in the second demarcation element.
31. A device according to statement 30, wherein the device is configured to respond to the sensed tension to operate the motor to cause the second demarcation element to be payed out from or retrieved onto the reel to maintain the tension of the second demarcation element within a pre-determined range.
32. A device according to any one of statements 30 to 31, wherein the reel is provided on an arm and is free to move relative to the body in a direction transverse to the longitudinal axis and is resiliently biased toward the body.
33. A device according to statement 32, wherein the sensing arrangement comprises a first switch for detecting the presence of the reel at a first position relative to the body.
34. A device according to statement 33, wherein the sensing arrangement comprises a second switch for detecting a second position of the reel relative to the body.
35. A device according to statement 32, wherein the sensing arrangement comprise a linear position sensor for measuring the relative distance between the reel and body.
36. A device according to any preceding statement, further comprising a controller for operating the device, wherein the controller is provided on the device.
37. A device according to statement 36, wherein the controller is configured to determine a position for the device along the first demarcation element.
38. A device according to statement 37, wherein the controller is configured to receive a first position at the time the device is provided onto the first demarcation element and configured to store this position as the current device position.
39. A device according to statement 38, wherein the first position is entered by a user on an input device.
40. A device according to statement 38, wherein the first position is provided by a GPS device.
41. A device according to any one of statements 38 to 40, further comprising an encoder for providing a measure of distance moved along the first demarcation element, wherein the first position is updated by the measure of distance moved to provide a current position for the device along the first demarcation element.
42. A device according to statement 41, further comprising a post detector for detecting a post along the first demarcation element and for updating the current position of the device based on a previously stored position for the post.
43. A device according to statement 42, wherein the post detector is configured to individually identify posts.
44. A device according to any one of statements 36 to 43, wherein the controller is configured to operate the motor so that the device moves in steps.
45. A device according to statement 44, wherein the step size is in the range of 5 cm to 1 m.
46. A device according to statement 45, wherein the step size is in the range 15 cm to 60 cm.
47. A device according to statement 46, wherein the step size is in the range of 20 cm to 40 cm.
48. A device according to any one of statements 36 to 47, wherein the device comprises a communications device and the controller is configured to communicate using said communications device.
49. A device according to statement 48, wherein the controller is configured to receive a schedule for operation of the device via the communications device.
50. A device according to statement 49, wherein the schedule details the required movements of the device over a coming time period.
51. A device according to statement 50, wherein the communications device is a wireless device.
52. A device according to any one of statements 48 to 51, wherein the device is configured to communicate with an electric fence controller over the single demarcation element.
53. A device according to statement 48, wherein the device is configured to send a signal to cause the electric fence controller to reduce or increase the voltage outputted by the electric fence controller or is configured to send a signal to turn-on or turn off the voltage outputted by the electric fence controller.
54. A device according to statement 48, wherein a signal is sent prior to the device moving and a separate signal is sent after the device has stopped.
55. A device according to any preceding statement, further providing a switchable electric connection between the first demarcation element and a second demarcation element to allow an electric field present on the first demarcation to be switchably connected to the second demarcation element.
56. A device according to any one statements 48 to 55, wherein the device further comprises a camera, wherein the camera is positioned to capture an image of the pasture from the device along the second demarcation element.
57. A device according to statement 56, wherein the camera is mounted underneath the device.
58. A device according to statement 56 to 57, wherein the controller is configured to upload images captured by the camera using the communications device.
59. A support for a wire of an electric fence, the support comprising:
   a tubular guide for receiving the wire of the electric fence;
   a mounting feature for mounting the support to a fence post, an arm extending between the tubular guide and the mounting feature so that the tubular guide is raised above the fence post when the support is mounted on the fence post.
60. A control system for a movable electric fence, the control system being operable to:
   cause a motor to operate to move the electric fence; and
   to at least reduce the power to the electric fence when the motor is operating.
61. A control system for a movable electric fence, the control system being operable to:
   cause a motor to operate to move the electric fence; and
   having a sensor for detecting when an electric discharge occurs from the electric fence, wherein the control system is configured to at least reduce the power to the electric fence when the motor is operating and the sensor detects an electric discharge.
62. A control system according to statement 60 or statement 61, wherein the motor is one of a motor in a demarcation vehicle or a gate for a demarcation system.
63. A method of improving the positioning of a device moving along a wire fence where the wire fence is supported by vertical posts comprising the steps of:
   acquiring a first position using a global positioning system to identify the position of the device with a first accuracy,
   detecting the presence of a vertical post,
   checking for the pre-stored position of the vertical post,
   refining the first position based on the detection of the vertical post, and updating the position of the device using a measure of distance travelled along the wire fence by the device.
64. A gate for a fence, the gate comprising:
   a base,
   a guide for guiding the wire of a fence;
a vertical support extending between the guide and the base, wherein the vertical support is extendible between a first position and a second position relative to the base;
   a communication device for receiving a control signal from a controller to operate the gate;
   an actuator for moving the vertical support between the first and second positions in response to receipt of the control signal.
65. A gate for a fence according to statement 64, the gate further comprising a GPS device for determining the position of the gate and for providing this through the communications device to the controller.
66. A gate according to statement 64 or 65 further comprising a sensor for confirming the actuation of the gate.
67. A system for a movable paddock within a pasture; the system comprising:
   a first demarcation element and a second demarcation element which define opposite first and second sides of the paddock; a movable demarcation element defining a side of the paddock transverse to and extending between the first and second sides of the paddock;
   a local controller provided on the movable demarcation element for controlling the movement of the demarcation element, the local controller having a positioning system for determining a position of the movable demarcation element along one of the first or second demarcation elements, the local controller having a communications device for establishing a data connection with a remote controller, the remote controller providing the user with a graphical user interface presenting the user with a graphical representation of the pasture and indicating the position of the movable wire fence in the pasture.
68. The system of statement 67, further wherein the graphical user interface includes an indication of the position of the movable fence at future times, the remote controller providing the user with an input allowing the user to alter the times or positions indicated, the remote controller being configured in response to this input to send a signal to the local controller, the local controller being responsive to the signal and adjusting the speed of movement of the movable demarcation element.
69. The system of statement 67 or 68, wherein the graphical user interface is configured to allow a user to enter a grazing requirement, which may for example be provided as the number of animals in the paddock and the feed required per animal over an extended period, and the system is configured to automatically calculate the required area of land to be made available by the movement of the demarcation elements during a given period of the extended period to accommodate this and to provide control signals to a demarcation element so that they move to positions which result in this area being made available to animals in the given period.
70. The system of statement 69, wherein the extended period is a day and the system is configured to calculate for any given period of the day by allocating different percentages of the daily total at different given periods of the day to account for animals natural grazing habits.
71. The system of any one of statements claims 69 to 70, wherein the grazing requirement is entered as a grazing feed weight per animal and the system is configured to convert this to a grazing area requirement.
72. The system of statement 71, wherein the system is configured to accept a crop (e.g. grass) height value for the crop in the paddock in advance of the demarcation elements and is configured to account for this in the conversion to the grazing area requirement.
73. The system of statement 72, wherein the crop height value is obtained using an image captured by an imaging device on the movable demarcation element.
74. A system for demarcating an area within a pasture; the system comprising:
   a first demarcation element and a second demarcating element which define opposite first and second sides of the area;
   a first demarcation vehicle provided at a first side and movable along the first side, a second demarcation vehicle provided at the second side and movable along the second side,
   a first movable demarcation element extending between the first and second vehicles, the first movable demarcating element defining a third side of the area;
   a third vehicle provided at a first side and movable along the first side,
   a fourth vehicle provided at the second side and movable along the second side,
   a second movable demarcation element extending between the third and fourth vehicles, the second movable demarcation element defining a fourth side of the area;
   a control system for controlling the movement of each of the vehicles, wherein the control system is operable to adjust the individual position of each of the four vehicles to perform at least one of:
   a) moving the area within the pasture;
   b) altering the size of the area; and
   c) altering the shape of the area.
75. A method of operating a demarcation vehicle configured for making progress within a pasture to adjust a grazing area by movement of a first demarcation element, the method comprising the steps of:
   monitoring the demarcation vehicle to ensure its ability to make progress;
   detecting a problem with the demarcation vehicles ability to make progress;
   operating a release mechanism or tensioning element to cause the tension in the first demarcation element to reduce so as to allow the demarcation element to fall at least partially to the ground.

It will be appreciated that each of these aspects may be used separately or combined together in a variety of combinations to advantage as will be appreciated from the description which follows unless the context contradicts it.

### DESCRIPTION OF DRAWINGS

These and other aspects will now be described in greater detail with reference the accompanying drawings in which:

FIG. 1 is a system in accordance with a first aspect of the present application;

FIG. 2 is an illustration of a movable demarcation element in a pasture to provide for forward grazing by animals according to a second aspect of the present application;

FIG. 3 is modification of the arrangement of FIG. 2 including a second movable demarcation element, for example to prevent back grazing;

FIG. 4 is an illustration of how the arrangements of the present application may be controlled to operate in an irregularly shaped pasture;

FIG. 5 is a top view of an exemplary wheel arrangement for a demarcation vehicle;

FIG. 6 is a side view of the arrangement of FIG. 5;

FIG. 7 is a perspective view of the arrangement of FIG. 5;

FIG. 8 is an end perspective view of a demarcation vehicle assembly comprising the wheel arrangement of FIG. 5;

FIG. 9 is a side perspective view of the demarcation vehicle assembly of FIG. 8;

FIG. 10 is an illustration of a drive wheel suitable for use in a demarcation vehicle;

FIG. 11 is an illustration of an insulator according to another aspect of the present application;

FIG. 12 is another view of the insulator of FIG. 11;

FIG. 13 is a view of a controller for a demarcation vehicle;

FIG. 14 is a schematic diagram for a controller such as shown in FIG. 13;

FIG. 15 is an illustration of an actuatable post for use in a gate for a demarcation element in accordance with a further aspect of the present application;

FIG. 16 is an illustration of a graphical user interface according to a further aspect of the present application;

FIG. 17 is a further exemplary demarcation vehicle, and

FIG. 18 is an example of a method which may be employed as an animal welfare measure in a demarcation vehicle.

### DETAILED DESCRIPTION

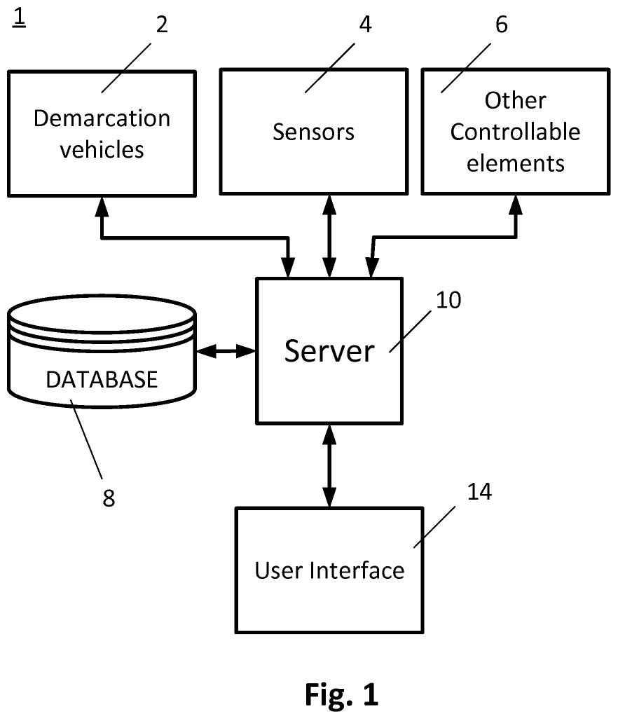

As shown in FIG. 1, the present application provides a system 1 for demarcating an area within a pasture. The system comprises a plurality of demarcation vehicles 2 which operate to move the position of a demarcation element in a pasture or other grazing area. The demarcation element may be a wire, rope or tape fence. The wire, rope or tape fence is suitably of the type employed for electric fencing.

The server 10 is operable to control the movement of individual demarcation elements.

A database or data store 8 is used to store information required by the server for operation. A user interface 14 is provided to allow a user to interact with the server to view the operation of the demarcation system or to program the operation of the demarcation system as will be more fully described below.

The user interface is suitably a web-based interface made available to users on the Internet, details of which are described in greater detail below. Similarly, an application (App) based interface may be provided allowing a user access to the server through their mobile device or computing device.

As will be described below, the server may interact with other controllable elements 6, for example an automatic gate to provide additional functionality beyond mere demarcation. another controllable element may be a power supply to an electrification system employed to energise a demarcation element (i.e. an electric fence). Yet another controllable element may be associated with a milking system.

The server may also interact with one or more sensors 4 separate from the demarcation vehicles or controllable elements. As an example, a sensor might be a rain sensor. Another sensor might be an imaging system for imaging the pasture to determine grass quality or level.

Suitably, the server and database is cloud based and the other elements are communicatively coupled to a server by a suitable internet connection using any of a variety of techniques which would be familiar to those skilled in the art.

The server is suitably configured to operate for multiple users/multiple pastures. Accordingly, different users may be identified by unique user names with appropriate security including for example passwords.

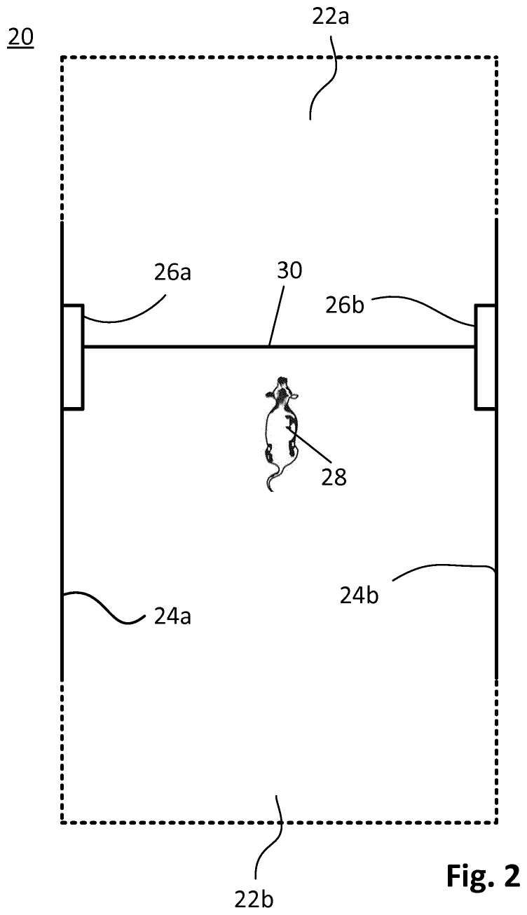

However, for the purposes of explanation, the operation of the system will be described in the context of a single pasture 20, for example, as represented in simple form in FIG. 2.

The pasture shown has a first demarcation element 24a defining one side of the pasture, with a second (opposite) side of the pasture defined by a second demarcation element. Suitably each of these demarcation elements is a wire fence comprising a wire run long a plurality of fence posts.

The pasture is shown in dashed outline indicating that it may be significantly longer than shown. Suitably however the pasture is longitudinal in shape, i.e. that the pasture is longer (lengths of first and second demarcation elements) than it is wide (distance between first and second demarcation elements).

The pasture is divided into two areas 22a, 22b by a third demarcation element 30. The third demarcation element is movable. The freedom of a grazing animal, 28, to move is confined by the three demarcation elements to the area 22b. The third demarcation element extends between a first demarcation vehicle 26a and a second demarcation vehicle 26b. As a demarcation vehicle moves, it causes the associated end of the third demarcation element to move accordingly. It will be appreciated that there may be further demarcation elements at either end of the pasture to enclose it, which might be walls or fences.

The third demarcation element may be supported by one or more tumble wheels as described above in the background of the application. These tumble wheels centrally support the wire of the demarcation element and allow it to be pulled along. Other manners of support could be used, e.g. supports on wheels.

Generally speaking, the first and second demarcation vehicles cause the third demarcation element to move along a longitudinal axis of the pasture. As the vehicles move forward the size of area 22a reduces and the size of area 22b increases. Thus the nature of the grazing method is termed forward grazing as the animals move forward as new grazing becomes available with the forward movement of the third demarcation element.

The demarcation vehicles are not restricted to forward movement and may also operate in reverse.

Conventional demarcation systems are normally restricted to rectangular shaped paddocks.

In a rectangular paddock, the first and second demarcation vehicles move at the same speed.

However, in the system of the present application, each demarcation vehicle is individually controllable. Thus, the effective speed of one demarcation vehicle may be selected to be faster than the other. This for example, allows for adjustments if a field curves to the left or the right.

In one mode of operation, the demarcation vehicles are programmed to move an incremental distance in accordance with a predefined schedule. The incremental distance is selected so that the additional grazing made available by moving a demarcation vehicle is limited. Suitably, the incremental distance (step size) is greater than 5 cm. It is an advantage to have operate the vehicle to operate in steps rather than at a constant slow speed as it is more efficient from an energy usage perspective as the vehicle may switch into a low power state in the time interval between movements.

Ideally, the step size is less than the distance between the points of contact on the ground of adjacent spokes on a spider wheel, which is conventionally 90 cm.

The rationale for limiting the step size to such a range is that it limits the amount of new pasture available to the animals for grazing at any one time. Previous vehicles have employed significantly longer distances, e.g. over 5 m. The use of a long distance meant that the animals did not optimally graze. Instead the animals have a tendency to trample over un-grazed areas as they move forward. This is because the animals' attention is led by the movement of the first demarcation element, which because it is where the animals feed may be referred to as the feed line. By limiting the incremental distance (or step size), optimum grazing can be achieved as the forward speed of the feed line can be linked with the grazing rate of the cattle as will be explained in greater detail below in the context of scheduling operation of the demarcation vehicles. Suitably, the step size is limited to be within the range 15 cm to 60 cm. Experimentally, it has been found that limiting the step size to be in the range of 20 cm to 40 cm works well for most arrangements.

To make control easier, typically one of the demarcation vehicles is selected to have a constant step size, which may be for example 30 cm. The step size of the second demarcation vehicle is then adjusted based on the relative lengths between the first and second demarcation elements. Thus if the length of a first side of the pasture is 300 m and the second side is 350 m, then if a step size of 30 cm was selected for the vehicle on the first side then selecting a step size of 35 cm ensures that after a 1000 steps both vehicles will be at the end of the pasture. Using such an approach, makes for simple control, since the only information required to be communicated to the vehicle for any given movement is the step size and the step interval (i.e. the time between steps).

The speed of a demarcation vehicle when moving is suitably selected to be of the order of 1 m per minute.

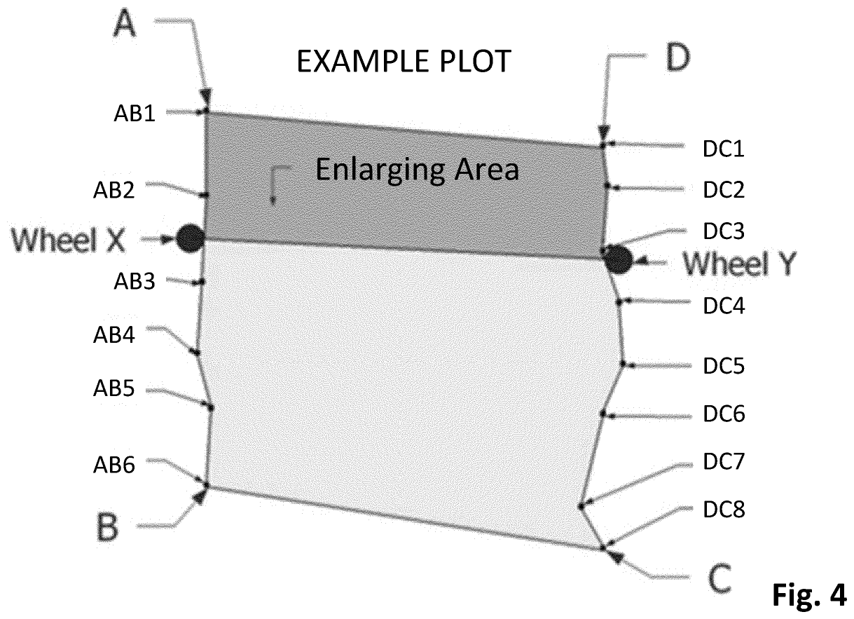

One or both of the demarcation vehicles may have a length adjustment device for increasing or decreasing the length of the third demarcation element. Such an adjustment allows for different widths of paddock to be accommodated. It also allows for different shaped pastures to be accommodated. For example, FIG. 4 illustrates different positions at set intervals for two respective demarcation vehicles (wheel X, wheel Y) and illustrates how an irregular shaped pasture may be accommodated by adjusting the incremental distance moved by each of the two demarcation vehicles relative to one and other.

This ability to adjust the incremental distance moved by individual demarcation vehicles also provides the ability to urge cattle in a particular direction. For example, if it was desired to move cattle in a direction toward the first demarcation vehicle and away from the second demarcation vehicle, then causing the second demarcation vehicle to slow down relative to the first demarcation vehicle will mean there is more grazing available closer to the first demarcation vehicle which in turn will act as an attractor to cattle. This could be used for example to move cattle to a particular side of the paddock at a particular time.

Suitably, the pasture is mapped and stored in the database of the server. More specifically, suitably the boundaries defined by the first and second demarcation elements are mapped to define two sides of the pasture, the remaining two sides of the pasture which equally may be defined by the presence of non-movable demarcation elements may also be stored so as to define the overall boundary of the pasture. In this context, it should be appreciated that the boundaries of the pasture need not necessarily be straight lines and thus the pasture may be any arbitrary shape and need not be rectangular in nature as shown.

Each of the vehicles has a positioning system for determining its position within the pasture. The positioning system may be a localised referential one providing a position relative to the reference points about the pasture or it may for example be based on absolute co-ordinates, for example, as might be obtained from a global satellite navigation system such as for example GPS, GLONASS, GALLILEO or BEIDOU. An advantageous positioning system is described later in the application.

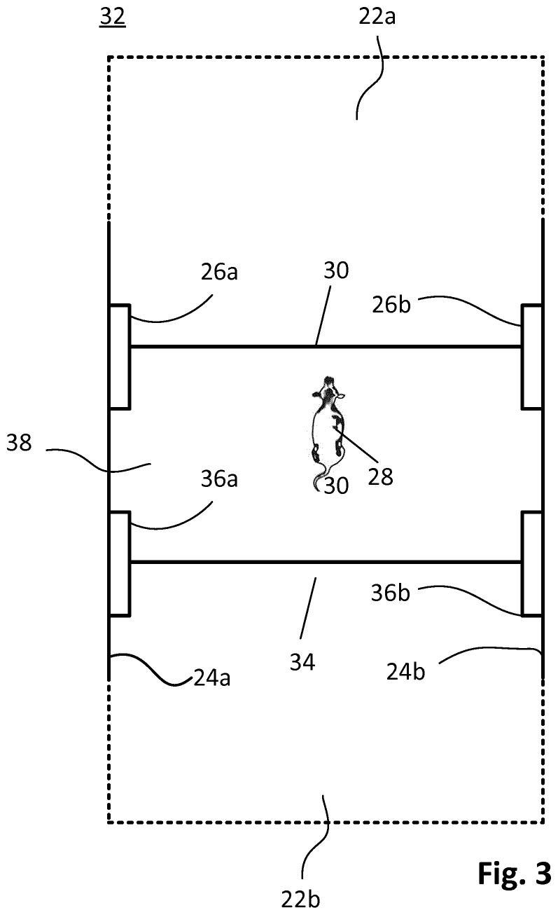

The application is not restricted to using two demarcation vehicles. An example is shown in FIG. 3 in which the arrangement of FIG. 2 is modified to provide a system 32 that allows for front grazing but at the same time prevents the cattle from back grazing (going backwards and grazing on previously grazed grass). There a number of advantages to having such an arrangement. It allows for example for a person to safely inspect an area that has been grazed. It can also be used to ensure the animals are in particular area, for example beside a gate at a time of milking.

The modified system 32 includes a fourth demarcation element 34. The fourth demarcation element in turn may be movable by demarcation vehicles. In the arrangement shown, a third demarcation vehicle 36a is provided at one end of the fourth demarcation element and a fourth demarcation element is provided at the opposite end of the fourth demarcation element. The third and fourth demarcation vehicles co-operate together to move the fourth demarcation element along the pasture. The third and fourth demarcation vehicles may be identical to the first and second demarcation vehicles in construction and operation.

The third and fourth demarcation vehicles operate similarly to the first and second demarcation vehicles thus allowing the size and shape of the area 38 between the first, second, third and fourth demarcation elements to be varied. The only constraint is that the third and fourth demarcation elements define a generally straight line (albeit with a limited curve since they are pulled along) between their respective demarcation vehicles.

As the fourth demarcation element will be behind the animals as they graze at the feed line, it may be referred to as the back line. It will be appreciated that greater care may be required to operate the back line since it will typically be moving towards animals whereas the feed line will be moving away from them.

Accordingly, special measures may be employed to reduce the risk when moving the back line as will be described below.

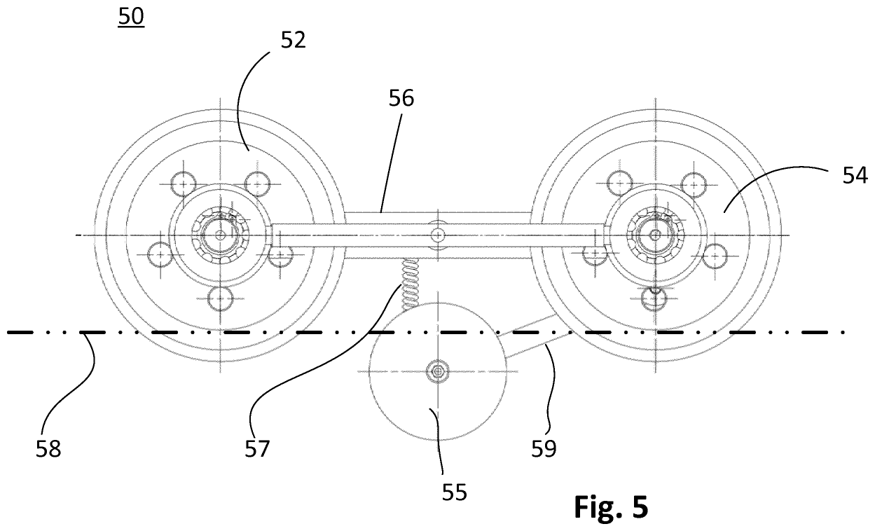

An exemplary demarcation vehicle according to one aspect of the application will now be described with reference initially to a wheel assembly as shown in FIGS. 5 to 7.

The wheel assembly employs one or more wheels 52, 54 to move along a demarcation element. The wheels provide support for the vehicle. In this instance, the demarcation element is suitably a wire fence and the wheel assembly moves along a single wire of the wire fence, which is suitably tensioned. The longitudinal axis 58 of where this single wire will be positioned is shown in dashed dotted outline in FIG. 5

More particularly, it is intended for use along wires which are of the type conventionally employed for operation as electric fences. The wire will suitably be relatively uniform and not have barbs or other protrusions.

The wheel assembly shown employs two wheels 52, 54 in moving along the wire. The use of two wheels provides a more stable platform than using a single wheel, however a single wheel may also be used. Similarly, the wheel assembly may have more than two wheels.

The device has a first wheel 52, the peripheral surface of which is suitable for moving along the wire of the single wire fence. The diameter of the first wheel is suitably of the order of between 3 cm and 18 cm, suitably is about 11 cm. In the context of this application, the reference to single wire fence does not exclude the presence of other wires, merely that the device itself moves along just one wire. The single wire itself may be a single filament or a multiple stranded wire.

The first wheel is connected to an actuator which causes the wheel to rotate. Suitably, the actuator is a drive motor 60 which in turn drives rotation of the first wheel causing it to act as a drive wheel. The motor comprises an electric motor which is mechanically connected to and drives the first wheel through a gear box. The nature of the motor-gearbox arrangement is such that the speed of movement of the first wheel along the guide wire is of the order of between 0.2 m/min and 10 m/min in operation, suitably the speed is 1 m/min. A suitable motor is one which provides a normal torque of about 5 Nm with a peak torque of about 10 Nm.

The first guide wheel is connected to a body 56 and provides support for it. The guidewheel is free to rotate around the longitudinal axis of the wire. The second wheel is connected the first wheel by the body and is at the opposite end to the first wheel. The axis defined by the centres of each of the first and second wheels is parallel to the longitudinal axis of the wire.

The distance between the two axes being defined by the radius from the point of contact of the wire with the peripheral surface of the wheel 56 to the centre of the wheel 56. The wheels have an outer diameter of between 30 and 180 mm. A more preferred range is between 60 and 130. In practise, a diameter of 110 mm has proven reliable.

The outer dimeter does not reflect the point of contact with the wire but rather than outermost diameter of the reel, i.e. the outer rim. The inner rim defining where the wire is normally in contact suitably has a diameter between 20 mm and 150 mm. A more preferred range is that of 70 and 100. A diameter of 86 mm has proven reliable with the 110 mm outer diameter.

The second wheel may simply operate as a guide wheel moving freely. Alternatively, it may be a drive wheel operated by an actuator. It will be appreciated that driving the second wheel reduces the effort on the first wheel and so reduces the risk of slippage of the wheel assembly on the wire. Similarly, it advantageous that the second wheel is a drive wheel so as to allow the first wheel to pass over insulators on the wire whilst ensuring the drive momentum is maintained along the wire.

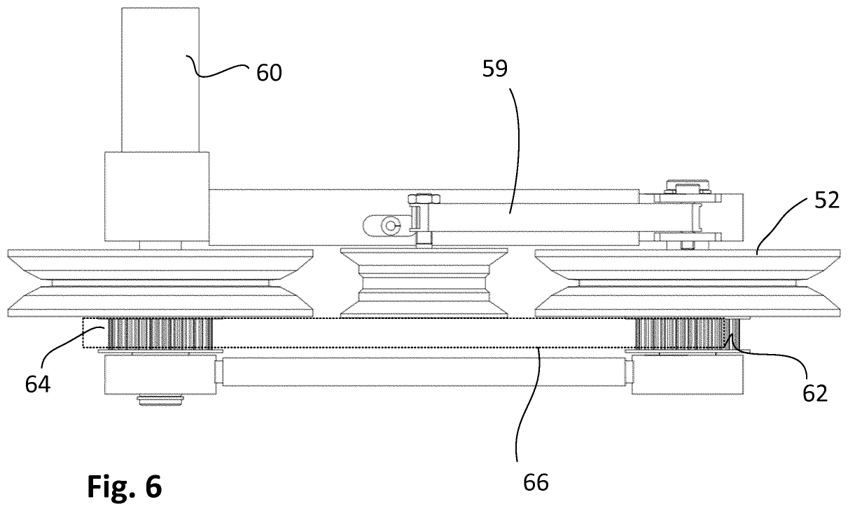

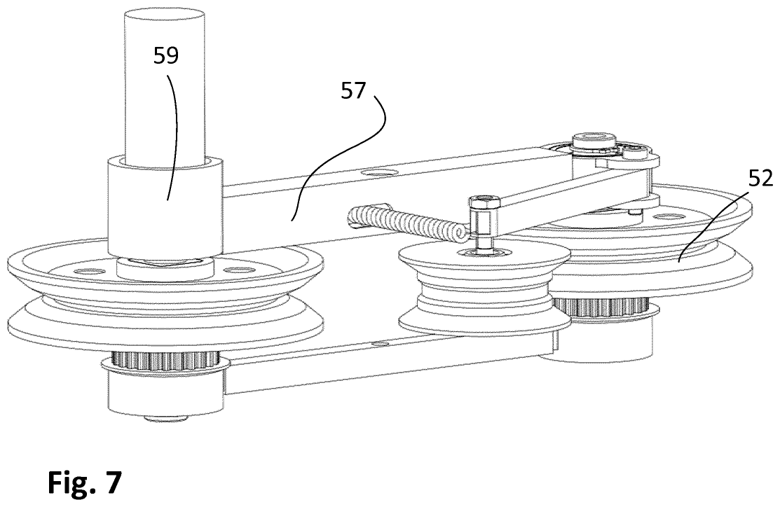

Although, separate actuators (e.g. drive motors) may be employed for each of the first and second wheels, this would add additional weight which is undesirable. Accordingly, the same actuator is used to drive both wheels. In the wheel assembly shown, a toothed wheel 62, 64 is provided on respective first and second wheels and a drive belt 66, gear or chain couples the rotation of the first and second wheels. The drive belt is shown in dashed outline in FIG. 6 and omitted from FIG. 7 for purposes of ease of illustration.

As will be discussed below the wheel assembly is held on the wire by tension exerted by the demarcation element the drive vehicle is pulling along. No other mechanism is required to maintain the vehicle on the single wire.

To reduce the risk that a shock load, e.g. an animal nudging against it, might cause the wheels of the wheel assembly to jump off the wire, a guide wheel is provided on the opposite side of the wire to the first and second wheels. The centre of the guide wheel is suitably co-incident with a mid-point of the body between the two wheels. The guide wheel is connected to the body by an arm which in turn is pivotably connected to the body so as to allow the guide wheel to move in and away from the longitudinal axis of the wire. In use, the guide wheel may be pulled in a direction away from the body to allow the wheel assembly to be placed onto the single wire. A resilient bias, suitably a spring 57, urges the guide wheel toward the body. Accordingly, in use, the single wire is somewhat restrained between the first and second wheels and the guide wheel.

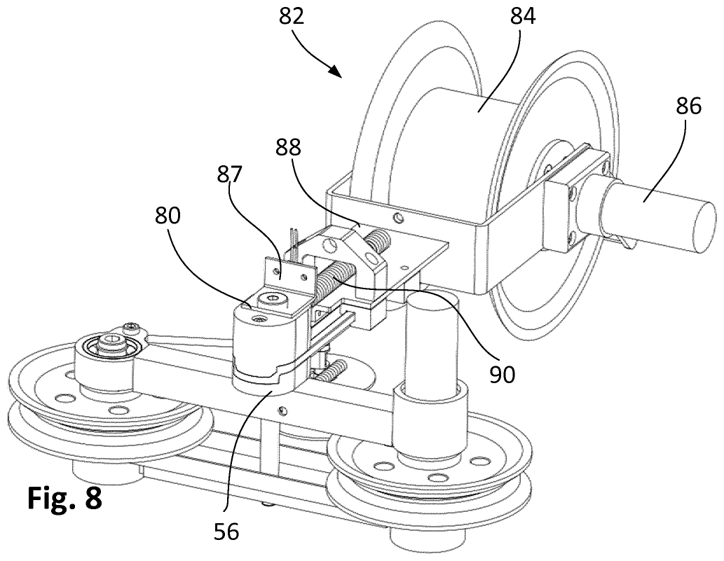

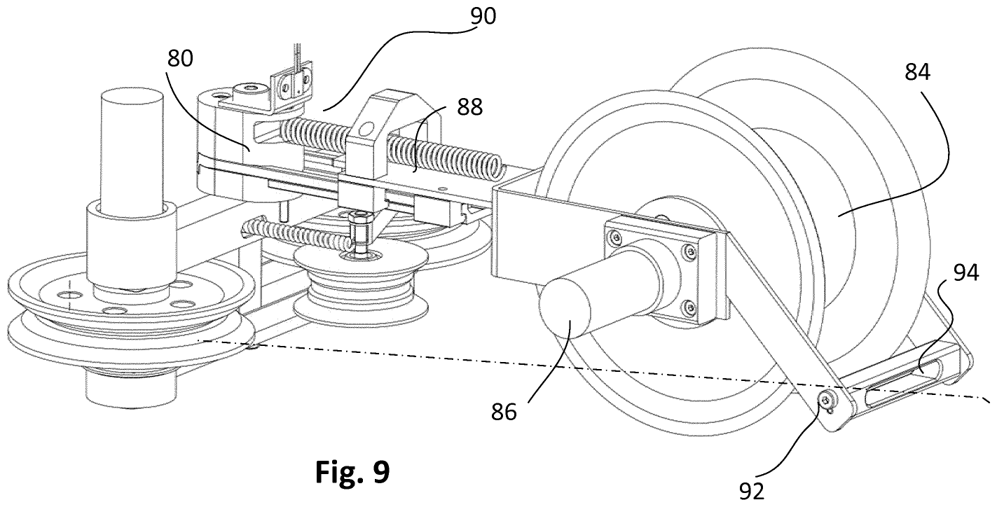

The wheel assembly in turn provides support for a first arm 80 as shown in FIGS. 8 and 9. More particularly, the body of the wheel assembly supports an arm at the opposite end of which a received is provided for receiving an end of the demarcation element that is being moved.

The arm is mounted to the top of the body. This means that the arm is raised above the wheels, which means that the arm can pass over the top of a post. Suitably the clearance between the arm and centre of the wheels (where the wire passes) is of the order of 0.5 cm to 30 cm and is suitably 4 cm.

The arm in turn supports an attachment feature allowing a demarcation element to be connected to the demarcation vehicle.

In the case where the distance between the two opposing demarcation vehicles is maintained constant, the attachment feature merely is required to provide a connection but may include a resilient feature, such as a spring.

If the distance between the two opposing demarcation vehicles is to change then the attachment feature on one of the two demarcation vehicles is required to be configured to pay out or take in the demarcation element.

Accordingly, in one arrangement, the attachment feature is a reel 82 mounted to the arm 80. The reel comprises a drum 84 around which the material forming a demarcation element may be wound.

Suitably this material is one of tape, rope or wire. For example, the material may be polywire rope or tape.

Using a reel allows for different widths of pasture to be accommodated. A tensioning mechanism is provided to ensure that the tension in the demarcation element remains with a limited range. This may be in the form of a wound spring, for example integrated into the drum.

Alternatively, a drum motor 86 may be provided to cause rotation of the demarcation element material around the drum as it is payed out or wound in. Tension in the demarcation element material maintains the arm in a generally horizontal alignment between the first wheel and the drum. As such, this tension limits the rotation of the first wheel about the longitudinal axis of the wire on which it runs along.

The reel is mounted on a second arm 88 which is slideably mounted to the first arm 80 allowing it to move in a direction transverse to the longitudinal axis of the wire. A resilient member (for example a metal spring 90) biases the reel in a direction towards the body. As tension in the demarcation element attached to the reel increases, the reel is caused to move against the bias from the resilient member toward the demarcation element. A sensor is provided to detect when the tension increases above a predetermined level. Upon detection of this, the device is configured to operate the drum motor to pay out the demarcation element. The sensor may be a position switch detecting when the arm has moved past a pre-determined distance from the body.

Similarly, a second sensor may be provided to detect when the tension in the demarcation element has fallen below a further predetermined level. Upon detection of this, the device is configured to operate the drum motor to take in the demarcation element. The second sensor may be a position switch detecting when the arm has moved within a pre-determined distance from the body. Alternatively, a linear position sensor may be employed to measure the relative position between the first and second arms to provide a measure of tension.

Although it will depend on the particular arrangement, including the type of demarcation material employed, experimental results have shown that the tension should be at least 5 kg and suitably more than 6 kg to ensure that the tumble wheels remain upright. This value determines the lower value of the range of tensions required. With the upper value, it is important that undue tension is not applied as this can increase the power required to move a demarcation vehicle. Accordingly, it has been determined that a reasonable upper limit for tension is that equivalent to a 15 kg weight. A selected mode operation has been to have a set point tension of around 11 kg with hysteresis of approximately 2 kg on either side.

Thus if the tension falls below 9 Kg, the drum motor will be activated to wind in the demarcation element until the tension reaches 11 kg and similarly if the tension raises above 13 kg, the drum motor will be activated to pay out the demarcation element.

Equally, the vehicle may be configured so that different tensions are applied at different times. Thus, for example, a higher tension may be applied after a vehicle has moved to try and cause the tumble wheels to rotate and thus line up. Thereafter, the tension could be reduced again.

To maintain the vehicle wheels in a horizontal alignment, it is desirable that the point at which the demarcation element engages the reel is co-planar with the wheels, as illustrated by the dash-dotted line in FIG. 9. To facilitate this a guide 92 is mounted on the reel, the guide has a mouth 94 through which the demarcation element is received before the drum.

A controller, which will be described in greater detail below, is provided for controlling the operation of the drive motor. A power supply is provided on the demarcation vehicle for powering the drive motor and controller. Suitably, the power supply comprises a battery, more suitably a re-chargeable battery. The choice for battery capacity will depend on a number of factors including the load and intended maximum period of operation. In this context, it is intended that the capacity be such that the battery will require replacing once a day, so as to ensure that farmers are encouraged to inspect the pasture and the animals. In this context, it will be appreciated that an energy capacity representing anywhere between 1 and 2 days usage would satisfy this requirement. At the same time, this limits the weight of the battery. It is also preferred that the battery is readily removable and accordingly, the battery is preferably mounted using a click-lock feature of the type which would be familiar to those using battery powered tools with rechargeable batteries.

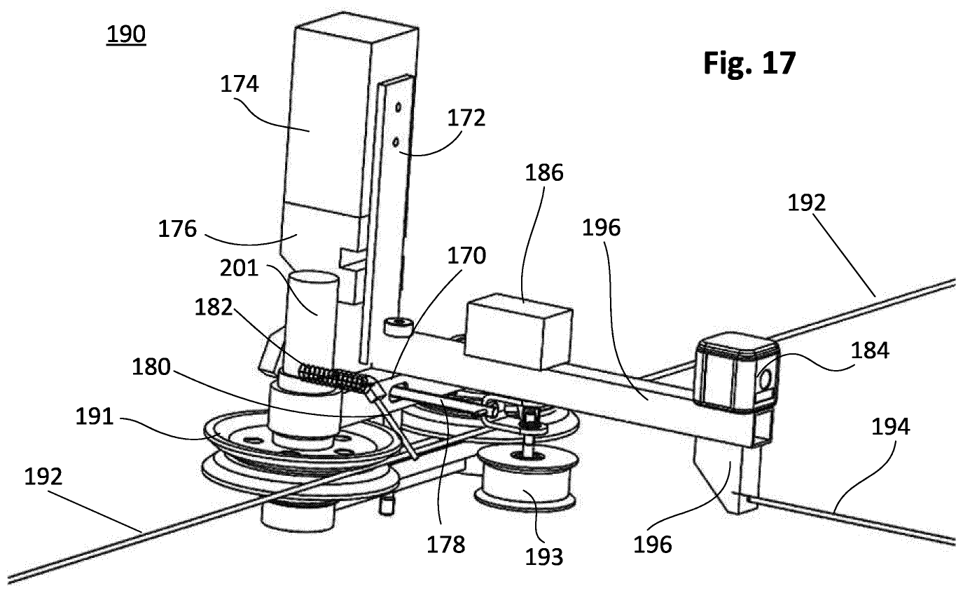

The controller and power supply may be housed within a housing on the body of the demarcation vehicle. This is illustrated in the arrangement of FIG. 17 which illustrates a demarcation vehicle without a reel.

To ensure that movement of the demarcation vehicle along a demarcation element is performed reliably, each of the first and second wheels or both may have a shape selected to ensure that the wheel grips the wire it is moving along. However, at the same time is selected to also allow for movement. In particular, it is desirable for the wheel to be configured to allow for the wheel to move without slipping but which also does not cause the wheel to lock-up on the wire.

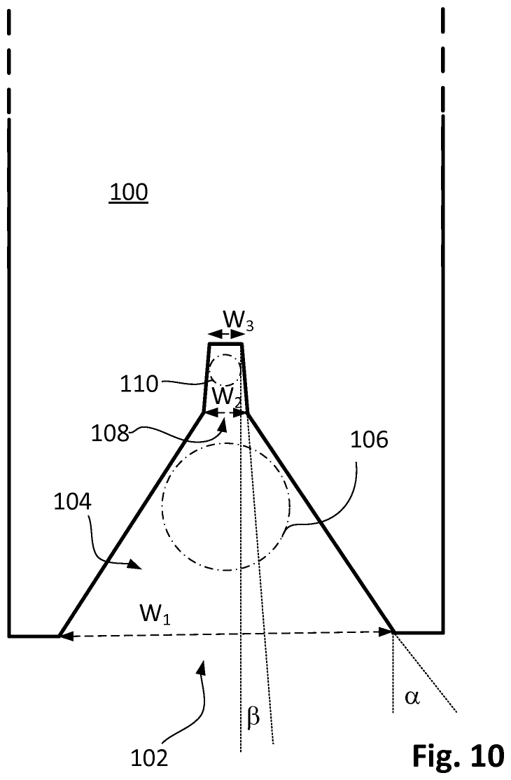

A wheel shape which has been determined to be effective is illustrated in FIG. 10, which illustrates the peripheral shape of the rim of the wheel having an opening 102 into which the demarcation element is received. The width of the opening w₁ is selected to be larger than the diameter of any insulator over which the wheel is required to pass. A reasonable size has been determined to be 15 mm for an expected insulator diameter of 12.5 mm. It will be appreciated that the diameter may be varied to operate with different diameters of insulator which may be in the range of 5 mm to 25 mm.

Side walls extend inward from the opening. The space between the side walls defines an outer region 104 in which any insulator 106 will be positioned as the wheel moves along it. The side walls extend to the mouth of an inner region 108 having a width W₂. The angle α of the side walls inward is selected to be between 10 and 70 degrees and suitably is about 40 degrees. The side walls need not necessarily be straight in the outer region and may for example be curved.

The inner region 108 is shaped to receive and grip a demarcation element 110. It will be appreciated that the dimensions will vary based on the diameter of the demarcation element employed. However, for a commonly employed 2.5 mm steel wire, the distance W₂ is selected to be 2.8 with reducing as the opening progresses inwards to an inner width W₃ of 2.2 mm. This reduction occurs over a distance of about 5 mm. The angle of the taper (β) is suitably in the range of between 2 and 7 degrees and suitably is about 4 degrees

It will be appreciated that the dimensions may be scaled to account for different diameters of insulator or wire.

The drive wheels 52 and 54 may be made of any suitable material. This may be a polymer material, ceramic or a metal. Although, it is generally preferable if the drive wheels are made from an electrically insulative material so that an insulating barrier is established between the demarcation element the drive wheels are moving along and the body and drive motor and more particularly the controller (described below) which typically comprises components which would be sensitive to high voltages as might be present on an electrical fence. At the same time, it reduces the risk of electric shock for any person attending to the vehicle. A suitable material for the wheel would be a polyurethane plastic mix, which may be adopted to allow a degree of flexibility for gripping the wire, whilst having sufficient hardness for durability.

It is desirable that the demarcation element attached to the attachment feature can be in electrical communication with the demarcation element along with the demarcation vehicle is moving. This may be achieved by providing an electrical connection between the guide wheel which may be made from a conductive material to the guide 92 on the reel. Although, it is simpler to make the electrical connection on the opposing demarcation vehicle (described below) where a reel is not required and similarly there is no need to measure the tension in the demarcation element.

It will be appreciated that conventionally a wire fence is conventionally supported by a series of one or more posts. Typically, the wire of the wire fence is supported at the side of a post by an insulator which may be a plastic tube or guide for receiving the wire. The demarcation vehicles described herein may not function properly with such arrangements as the posts may interfere with the motion of the wheels along the wire, limiting the operation of the device to situations where posts are on the inside (although this is not possible when a guide wheel is employed) or limiting the motion of the device between adjacent posts. In the case of the latter, it would be possible for a user to manually move the device past a post by lifting it off the wire and placing it back on after the post.

Nonetheless, it would be desirable for a more flexible mode of operation with the described demarcation device. Accordingly, the present application provides for a wire support feature for mounting on a post which keeps the wire a distance away from the post allowing for the device to pass a post without the post interfering in the movement of the device.

So that the wire is maintained in line with the posts rather than being offset horizontally from the post, the support is configured to position the insulator above a post.

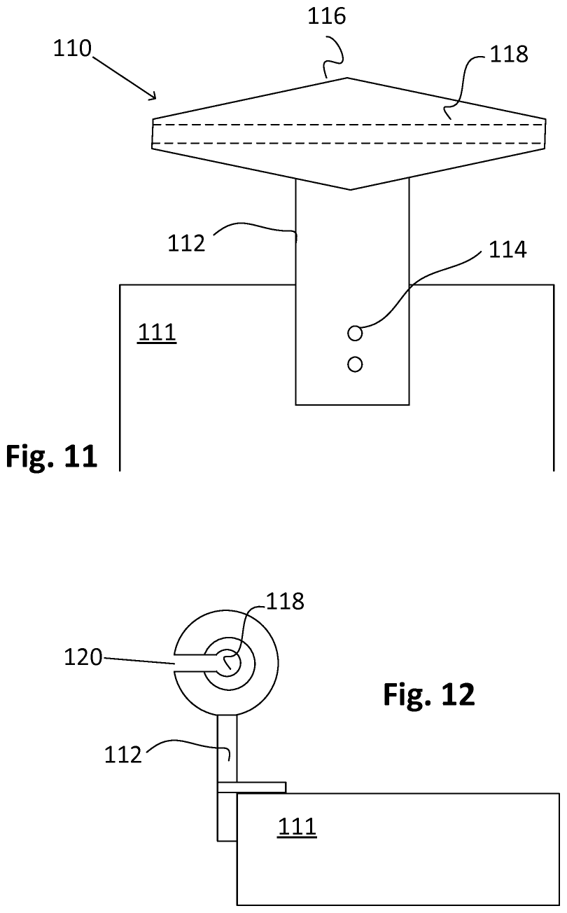

Thus as shown in FIG. 11, an insulator 110 for a wire fence is provided comprising a base having a mounting feature for mounting the support to a top or top side surface of a post 111. The mounting feature may comprise one or more holes allowing a fastener such as a screw to be used to fix the base to the post. An arm 112 extends from the base upwards from the post to an insulator body 116.

The arm may have a transverse support for resting on the top of the post if the arm is mounted to the side. Alternatively, the base may be formed in the shape of a fastener, such as a screw, allowing the base to be screwed directly into the top of a post. At the opposite end of the arm to the mounting feature, a guide is provided for receiving the wire of a fence. Suitably, the guide is a tube having a passage 118 through which the demarcation element may be run. The tube may be a split tube having a slit along its top side allowing for the wire to be placed laterally into the tube. This allows for the demarcation element to be removed or attached to the insulator as required. It will be appreciated that the purpose of the insulator is to provide support for a demarcation element and at the same time to electrically insulate the demarcation element from the post. To achieve this, one or more of the arm, base and tube may be formed from an insulating material, for example an insulating plastics material. To improve the transition on a wheel of the demarcation vehicle as it passes along and over the support, the support may be shaped so that the transition from the wire to the insulator is gradual rather than abrupt. Thus, as shown the outer diameter of the insulator body may increase from one end up to a maximum diameter at the centre and then gradually decrease to the other end. This shape acts to reduce bounce of a wheel of the demarcation vehicle on the wire and improves traction.

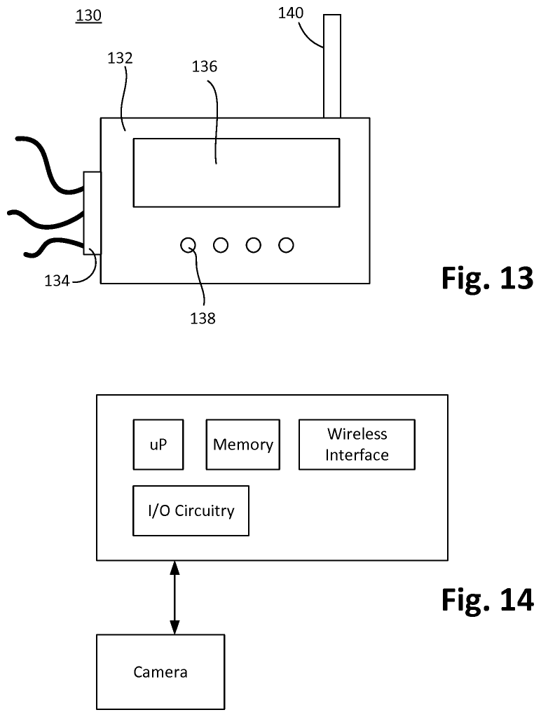

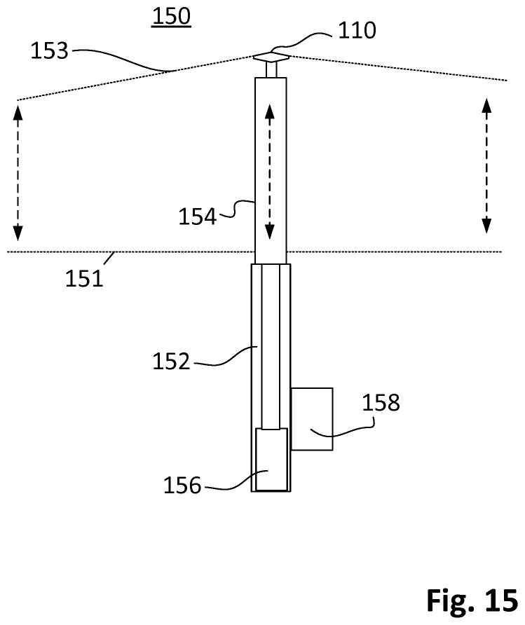

To control the operation of the demarcation vehicle, a controller is provided. Suitably the controller, is removable from the demarcation vehicle. A mounting feature 87 may be provided to allow the controller to be mounted to the demarcation vehicle. In the arrangement shown, the mounting feature is provided at the top of the body midway between the two drive wheels. The advantage of mounting the controller in this position is that it is readily accessible, whilst at the same time keeping it away from the high voltages associated with the wire of an electric fence along which the demarcation vehicle may be moving. The power supply for the demarcation vehicle may be provided in a housing with the controller or it may be mounted separately. An exemplary controller 130 is illustrated in FIGS. 13 and 14, suitably comprising a waterproof housing 132. One or more connectors 134 may be provided to facilitate electrical connections to the drive and drum motors and the battery. The controller may have a graphical display or other indicator (e.g. LEDs) to indicate the status of the controller to a user. Similarly, one or more buttons or other input features may be provided to allow a user to turn on or off the controller or to change a setting. One or more antennas for wireless communication or for receiving GPS positioning signals may be provided either external or internal to the housing.

The controller is configured so that it can perform a measurement of the distance travelled along a demarcation element. This may be by means of an encoder or other sensor measuring the rotations of one of the guide or drive wheels or of the drive motor.

Alternatively, it may be achieved by precise control of the drive motor, e.g. where it is a step motor and the controller is configured to count the steps performed. This has advantage as will be described below.

Internally, the controller has a microprocessor and associated memory storing software instructions for the operation of the controller. Input-output (I/O) circuitry is provided to allow control of the display, to receive inputs from the input buttons and to control the operation of the drive and drum motor (if present). A wireless interface is provided to receive positioning signals from a GPS antenna and to allow the device to communicate wirelessly with the sensor 10. The wireless communication may be by means of a WIFI, or cellular telephone technology for example, GPRS, GSM, CDMA or LTE.

The controller may also comprise a camera or have a connection to a camera mounted elsewhere on the demarcation vehicle. Suitably, this camera is positioned to capture an image of the grass (or other crop) along the feed line. The controller may be configured to analyse the image to determine a measurement for the grass height before and after the feed line. The controller may use this measurement to adjust the rate of movement.

Similarly, the controller may upload images from the camera the server for viewing by a user or for further analysis. The point at which image is captured may be timed to be co-incident to the movement of the demarcation vehicle, for example an image may be captured immediately before movement and immediately after movement.

The controller may also have other connections and inputs. As an example, the controller may be provided with a connection allowing it to communicate over the wire of an electric fence with an electric fence controller (using power line communication technology).

Additionally, the controller may also be connected to a fence post sensor, which senses the presence of a post, this may for example be implemented using a sensor on the guide wheel or the arm of the guide wheel to detect when the guide wheel passes over an insulator. Equally, each post may be provided with an RFID tag or similar wireless identifier and the controller may have an associated reader for identifying the RFID tag as it passes. The advantage of using such unique identifiers is that the controller can identify not merely that it is passing a post but also which post it is passing.

There is a general concern amongst the public and farming community with respect to animal welfare. Whilst, electric fences are regularly used and animals are well adjusted to them, it is perceived that a difficulty may arise when an electric fence is movable as described above. This is particularly the case in respect of having a second movable demarcation element following a first to prevent back grazing. For example, the fence may catch an animal lying down facing away from the second movable demarcation element unawares resulting in the animal receiving a shock.

The system of the present application provides a feature which reduces this possibility. The feature may be provided by having a control system which when operating one or more the demarcation vehicles causes the power being delivered to an electric fence to be reduced. This power reduction may be in total for the entire arrangement. Alternatively, it may be selective and only applied to a demarcation element which is being moved.

In another approach, the system may be configured to detect for electrical discharges from the electric fence. As the system operates one or more demarcation vehicles to move a demarcation element, if a discharge is detected, the system may be configured to reduce the power delivered to the electric fence. It will be appreciated that the term electrical power, may be construed as being the voltage delivered to the electric fence.

Previous movable demarcation systems have not being able to accurately detect their position. More specifically, whilst devices are known which employ GPS, the accuracy of this is limited when the distances travelled can be extremely small in any time period.

The present application improves upon this by using a combination of different positioning systems. More specifically, a method is provided for improving the determination of a position of a device along the wire fence. The method comprises acquiring a first position when the controller is initialised or when it is placed onto a demarcation element. This initial position may be manually inputted by a user or detected for example using a global positioning system to identify the position of the device with a first accuracy.

This first position positions the device on a particular demarcation element. In this context, it will be appreciated that a demarcation vehicle may be employed on several different pastures within a farm. The demarcation elements, including the fence posts along same for each pasture would be pre-mapped and stored either locally in the controller or remotely in the server or both. In one arrangement, the controller provides the first position to the server. The server employs the first position to identify the demarcation element on which the demarcation vehicle has been placed and in turn retrieves mapping details for the demarcation element including the positions of the posts along the demarcation element. In this context, it will be appreciated that whilst an absolute 2 dimensions position is required for the initial position so that the demarcation element may be identified, subsequent positions may simply be relative ones, i.e. identifying the distance along the demarcation element. The advantage of this is that computation of position is simpler and requires less power.

As each post is pre-mapped, the controller can identify its position by detecting it is passing a post. It will be appreciated that as the demarcation vehicle must progress in a linear fashion along the demarcation element, it is not necessary to identify the individual post that its passed, merely its place in the sequence.

However, it is possible that fence posts may be moved or knocked down or replaced and accordingly it may be desirable that fence posts are uniquely identified. If the fence posts are uniquely identified, it also means that the initial position may be detected by the passing of a first post.

As the device moves past a post, the device detects the presence of the post and updates its position to the pre-stored position of the post. As the device continues to move, the position of the device is updated using a measure of distance travelled along the wire fence by the device. The advantage of using this combination is that the precise location of the device along the fence is known at any one time with a great degree of accuracy. At the same time, the detection of fence posts ensures that errors from slippage of the drive wheels may be compensated for.

A problem with a movable demarcation system is that the area of the pasture where the animals are grazing is constantly moving, this means that having gates to allow animals to go for milking is problematic. The present application provides a device which overcomes this difficulty. In particular, a device is provided which acts as a gate for an electric fence by raising the wire of the fence to allow animals to pass under the fence.

More particularly, a gate for a demarcation element such as a wire fence is provided.

The gate 150 comprises a base section 152 which has a height which would correspond generally to the height of a conventional fence post. The gate may be fixed to an existing post, or mounted for example in a receiver placed in the ground. A guide for the wire of the demarcation element (e.g. wire) is provided on a top section of the gate.

The gate operates by lifting the demarcation element from a normal level 151 to a height 153 sufficient to allow animals to pass under the demarcation element. To avoid undue strain on the wire of the demarcation element, the gate is suitably positioned to replace an existing post of the fence rather than being placed between two fence post. The gate suitably may be portable and moved as required. Thus, the guide may employ a split insulator, allowing the wire to be removed from the insulator of a fence post and simply placed into an insulator 110 provided on the gate to hold the demarcation element in place. In another approach, the insulator may be designed to be readily removable so as to allow the insulator carrying the wire of the demarcation element to be moved from a post to the gate.

The insulator is positioned on the top or top side surface of an extending section 154 of the post. The extending section is movable relative to the base section. In one arrangement, as shown the extending section is received within the base section. In a closed position of the gate, the top of the base section is proximate to the top of the extending section. In the open position of the gate, the bottom section of the extending section is proximate the top of the base. In this way, the extending section is movable relative to the base in a vertical direction from a position where the gate is closed to a position where the gate is open. An actuator 156, e.g. an electric motor, is provided to move the extending portion of the gate between the closed and open positions as required. The drive motor may drive a worm thread or other suitable mechanism to cause the extending section to move. The extending section may comprise multiple extending sections allowing the top of the extending section to extend to a height more than twice that of the base, whilst at the same time allowing for the extending section to retract into the base when closed. Desirably, the height of the insulator off gate off the ground when closed is in the range of 70 cm to 1 m and suitably is about 80 cm. Correspondingly, when the gate is open height of the insulator off the ground is in the range of 1.5 m to 2.5 m and suitably about 1.9 m.

A controller 158 is provided to operate the gate. The controller may be similar to the controller for the vehicle described above. More particularly, it suitably has a means of communication allowing it to communicate with the server, either directly for example via a wireless internet connection or via another device (for example a demarcation vehicle). The controller may have a position sensor (e.g. a GPS sensor) or a RFID sensor for detecting which fence post it has been placed at. This position may be fed back to the server, so that the server is aware of the position of the gate and can operate it at a desired time. It will be appreciated that multiple gates may be employed but advantageously, the gate may be moved as required. Thus, a farmer could pre-position a gate at a post where animals are expected to be by virtue of the demarcation vehicle for milking and the gate could be operated at that point. The gate may have a sensor to detect that the gate has in fact operated as required. In this context, it is desirable to know that not merely has the gate extended but that it has also lifted the wire of the fence and that this has not fallen out from the insulator or indeed that the wire was removed as required from a fence post and placed on the gate. Such a sensor may comprise a tension sensor or a voltage detector, e.g. detecting the presence on an electric field proximate to the insulator.

It will be appreciated that where a split insulator is employed, it would be desirable that the gate is only placed at a post which is substantially in line with the two adjoining posts so that the wire is not pulled from the insulator of the gate or the adjacent fence posts.

A significant advantage of the present arrangement over the prior art is that the extent of control of the grazing is significantly increased and more particularly the amount of fresh grazing made available at the feed line can be accurately determined. This means that the control available to a farmer is significantly improved. Additionally, schedules can be employed which reflect the grazing habits of animals ensuring that optimum grazing of a pasture occurs. This can result in a significant efficiency improvement of a pasture. At the same time, because the control of grazing is refined, it is possible to employ mixed crops, for example clover and grass, as the animals will only be able to each the limited amount presented at the feed line as opposed to unfettered grazing which would have precluded or disincentivised the use of mixed crops before.

The system can also be tied to sensors from milking parlours and as a result, the productivity of a particular crop can more accurately be measured. At the same time, the quality of milk produced can be compared for different crops. In contrast, the current approach is generally to employ grasses that grow the fastest, the use of the present grazing system allows for greater control and measurement of the performance of different crops.

An exemplary interface for the server allowing a user to control the operation of demarcation vehicles or the gates will now be described.

The interface allows a user to log-on using their unique credentials, which may for example be a combination of a username and password.

The interface allows for the overall management of the overall grazing on a farm. In this context, it allows a user to set up multiple pastures (paddocks) on the system. Once pastures have been set-up, the interface allows for a schedule to be created for rotation of the paddocks over a period of time. It will be appreciated that formulating such schedules is known and employed commonly by farmers. The interface takes this stage further as it provides for a significantly more accurate predictor of when grazing of a pasture will be complete and hence when a pasture should be rotated.

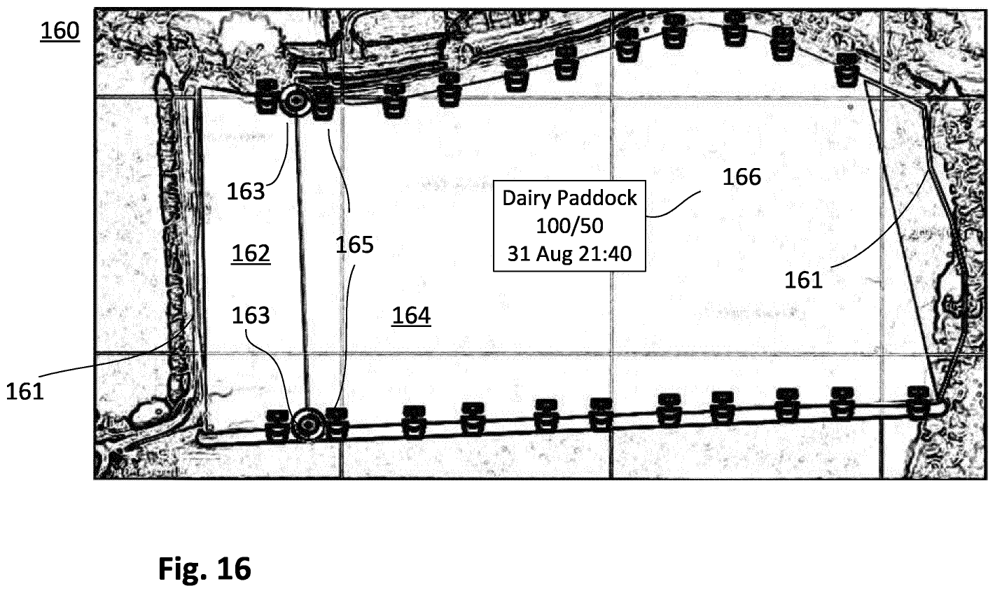

More particularly, the interface provides a user with a graphical representation of a pasture, as shown in FIG. 16. This map may be a representative map or it may be superimposed on image based maps, e.g. google maps satellite view.

The map 160 identifies the boundary 161 of the pasture. The map indicates the position of demarcation vehicles 163 in the pasture. In the exemplary arrangement shown there are two demarcation vehicles illustrated by circles, representing the feed line. The area which has been grazed 162 behind the feed is identified by a different colour, shade or other marking to the non-grazed area 164 in front of the feed line.

The points at which it is estimated that the demarcation vehicles will be at milking times are identified by icons 165 positioned along the side of the pasture.

An information label 166 is presented identifying information associated with the pasture. The information label 166 identifies the name of the pasture, e.g. “Dairy Paddock”.

The information window also identifies the inputted parameters for the herd which is grazing. In particular, it identifies the number of animals and the average area to be allocated to each animal. In the exemplary window, the figures provided are 100/50 representing 100 animals with an allocation of 50 m² per animal per day.

If a user clicks, double clicks or otherwise selects the information label 166, the user may alter the herd parameters. The information label may also further identifies the date and time.

Thus, the interface allows a farmer to identify the number of animals and the desired feed area per animal for a period of time (e.g. per day). This would be a measure familiar to those farmers engaging in strip farming.

As the pasture has been pre-mapped and stored in the server, the server is able to calculate the required rate of movement for the feedline and can instruct the demarcation vehicles accordingly. At the same time, the positions of animals at milking times may be indicated allowing a farmer to position a gate at that position as discussed above. The system may also allow a farmer to alter the timing to accommodate his schedule, thus the milking icons may be moved.

At the same time, obstacles may be included. For example, if a tree is present in the middle of a pasture, this may be shown on the interface and similarly, the schedule may be adjusted to cause the vehicles to stop motion of the demarcation element as it approaches the obstacle, allowing for a farmer to move the demarcation element around the obstacle (for example using a clip fitting at a point along the demarcation element).

The feeding of grazing animals is not uniform and accordingly, the area made available to the animals may be adjusted to ensure that the feed line moves at different speeds to that the feed made available is most efficient.

An exemplary schedule is provided below in table 1, for an example of 100 cows allocated 50 sq metres per head (5000 square metres total) over a 24 hour period representing the figures employed in FIG. 16.

| Percentage of grass | Area (Square Meters) | Time |
|---|---|---|
| 2% | 100 | 00:00-01:00 |
| | | 01:00-02:00 |
| | | 02:00-03:00 |
| | | 03:00-04:00 |
| | | 04:00-05:00 |
| 20% | 1000 | 05:00-06:00 |
| | | 06:00-07:00 |
| MILKING TIME | — | 07:00-08:00 |
| (no grass) | | 08:00-09:00 |
| 40% | 2000 | 09:00-10:00 |
| | | 10:00-11:00 |
| | | 11:00-12:00 |
| 16% | 800 | 12:00-13:00 |
| | | 13:00-14:00 |
| | | 14:00-15:00 |
| | | 15:00-16:00 |
| MILKING TIME | — | 16:00-17:00 |
| (no grass) | | 17:00-18:00 |
| 20% | 1000 | 18:00-19:00 |
| | | 19:00-20:00 |
| | | 20:00-21:00 |
| | | 21:00-22:00 |
| 2% | 100 | 22:00-23:00 |
| | | 23:00-24:00 |

It will be appreciated that as the pasture is mapped, the server can convert the schedule into a series of scheduled movements for the demarcation vehicles during each interval to correspond to providing the desired amount of grass in each time period. At the same time, the incremental nature of the demarcation vehicles movements (approx. 30 cm at a time) means that the animals are not over supplied at any one time.

The server in turn can communicate the schedule to the demarcation vehicles. The server will update the map with the estimated position of the demarcation vehicle based on the schedule over time unless and until the demarcation vehicles send an update of their position. The date and time at which the demarcation vehicles are expected to finish in the pasture, i.e. the date when the pasture is anticipated as being been fully grazed is also identified in the information label, i.e. 31 August 21:40.

A significant advantage of this approach is that an accurate comparison may be made between different crops and resulting milk production since the area made available and the timings they are made available is accurately controlled.

Additionally, the famer can view the images captured from the camera on the demarcation vehicle or indeed can inspect the pasture to determine if the grazing of an area has been optimal or not. It will be appreciated that this may vary on a daily basis as grass for example can grow very quickly and so the optimum feed rate on one day may be much less than on a previous day. However, the farmer can simply adjust the area to be made available per head based on an examination of the grazed land. As a result, the efficiency of the use of the land is dramatically improved.

As referenced above, there may be two types of demarcation vehicle with the first supporting a reel and a second having a simple point of attachment. An exemplary arrangement 190 for the latter is illustrated in FIG. 17. It will be appreciated that the construction is very similar to that of FIGS. 5 to 7 with the exception that a drum is not mounted on the arm 196 extending from the body 170 of a wheel assembly.

As before, the wheel assembly employs one or more wheels 191 to move along a demarcation element 192. The wheels provide support for the vehicle 190. In this instance, the demarcation element is suitably a wire fence and the wheel assembly moves along a single wire 192 of the wire fence, which is suitably tensioned.

The wheels of the device are as previously described. The arrangement, in contrast to FIGS. 5 to 7, shows the vehicle with the housing 174 for the controller and a rechargeable battery 176 mounted to it. A button, not shown, may be provided to allow the battery to be removed. A support 172 is provided to which the controller housing is mounted.

As before, the first wheel 191 is connected to an actuator (drive motor 201). The arrangement of the drive motor and the connections with the other drive wheel if required may be as described before.

A guide wheel 193 operates as described before, it is connected to an arm 178 which is sprung to cause it to be biased toward the guide wheel.

As will be discussed below the wheel assembly is held on the wire by tension exerted by the demarcation element the drive vehicle is pulling along. No other mechanism is required to maintain the vehicle on the single wire.

A contact 180 may be provided, for example in the form of a pivoted arm, to make an electrical contact with the wire 192 of the electric fence. The contact may be biased by a spring 182 or other element to maintain contact with the wire. A second contact (not visible in FIG. 17) may be provided adjacent to a second guide wheel so that contact is not lost when passing along and over an insulator on a fence post.

The contact is arranged to be in electric communication with the demarcation element 194 being moved which is attached at an attachment point 196 on the arm.

Suitably this communication is a switched connection, e.g. through switch module 186, which may be controlled by the controller 174. This allows for the selective local activation or de-activation of the electric fence element being moved by the demarcation vehicle. In this context, it will be appreciated that only one demarcation vehicle of a pair of opposing demarcation vehicles is required to make an electric connection to the electric fence it is moving along for the wire being moved to be electrified. Accordingly, the switch module need only be presented on one of the demarcation vehicles for local activation. Separately, as described below, there may be a communication means provided for remote activation or de-activation of the electric fence. However a disadvantage of remote activation is that the entire electric fence is required to be de-activated, whereas with the local switch module, the movable demarcation element may be selectively de-activated from the remainder of the electric fence.

As there is no drum present on the end of the arm 196, it provides an ideal position for placement of a camera 184 as discussed above.

As with the demarcation vehicles previously described, the arm 196 biasing the guide wheel may be connected to a sensor so that the controller can identify when the demarcation vehicle is passing by a post, which may be employed to advantage as previously described for positioning. The other features and characteristics of the demarcation vehicle will correspond to those previously described.

It will be appreciated that the devices and systems of the present application provide significant advantage over the prior art devices. More particularly, the system ensures that animal welfare is provided by ensuring that the grazing animals are fed at all times whilst ensuring the amount of pasture for grazing made available is limited.

This is achieved by having small movements which are enabled by the precise positioning system which is robust and reliable.

At the same time, by pre-mapping the pastures and pre-calculating the step sizes. We limit the information necessary for the program on the demarcation vehicles to run. At the same time, opposing pairs of demarcation vehicles are selected to have the same program (schedule) and the only difference between the two is occasional step size changes for one of the vehicles.

At the same time, the user interface provides a simulation of expected movements which runs on the basis of the same information used to control the demarcation vehicles. So if an error occurs, it will appear on the interface (map simulation), which limits potential errors, for example where mapping information has been incorrectly entered or a user has inputted the wrong parameters, for example 1000 cows instead of 10 cows.

As the vehicles are configured to move in increments of distance, for example about 30 cm, which is measured there is a high degree of accuracy.

The vehicles are configured to accept a schedule and to operate on the basis of the accepted schedule until they receive an updated schedule. This means that even if there is a breakdown in communication, the vehicle will still follow the schedule and a user can still expect the device to be in position as per simulation shown on the interface.

One particular configuration which may be implemented is that in the event of a communication breakdown, the demarcation vehicles of the back fence would be disabled from moving toward the feed line demarcation vehicles. This reduces the risk of electric shock to the animals. Under such circumstances, the back fence may be allowed to move in the opposite direction (i.e. away from the animals), for example to allow the animals to exit a gate for milking.

At the same time, it is envisaged that animal welfare issues may arise unexpectedly in the event of a power failure in a demarcation vehicle or a failure of a drive in a demarcation vehicle.

Accordingly, the system may be configured to detect for either or both of these situations and take action to ensure the welfare of the grazing animals.

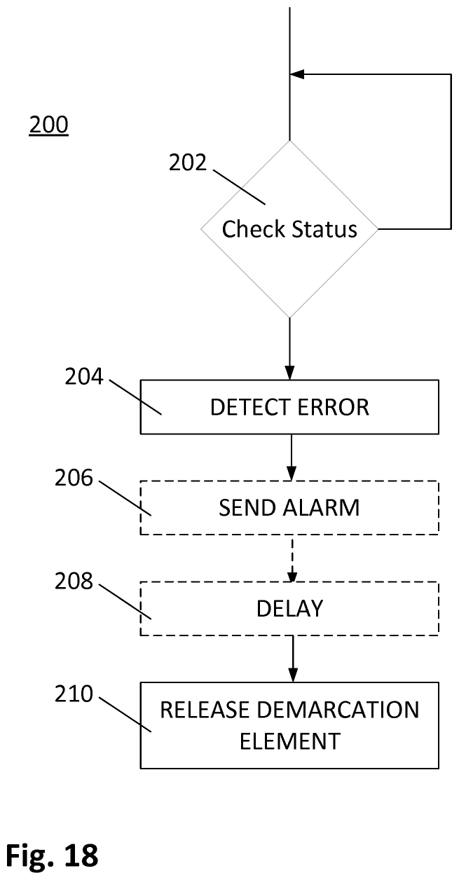

An exemplary method of implementing such a measure is shown in FIG. 18.

The method 200 commences with the system monitoring 202 for an error or failure in the operation or status of a demarcation vehicle.

As an example, the vehicle may be configured to compare a determined location with an expected location and where the difference exceeds a threshold value, an error may be flagged. This error for example might indicate a failure of the drive motor of the demarcation element or for example the presence of an object blocking the forward progress of the demarcation element.

As another example, the demarcation element may have a battery level detector detecting the level of the battery on the demarcation element and where the battery level falls below a threshold, an error is flagged.

It will be appreciated that in both of these conditions, the demarcation element may be failing to progress or about to fail to progress. As a result, the grazing land being made available to the grazing animals might cease.

Accordingly, the system upon detecting 204 such an error condition may take corrective action to ensure the on-going welfare of the animals.

This corrective action optionally may comprise communicating an alarm message to a user, e.g. by an alert on an application employed for operating the system, on their mobile device.

Optionally after sending such a message, the system may delay 208 for a period to allow a user to attend and clear the problem causing the error.

After such a delay (if employed), the demarcation vehicle may be activated to release 210 a demarcation element it is dragging along. Releasing a demarcation element may be employed by means of an actuator operating a demarcation decoupling feature which decouples the demarcation element from the demarcation vehicle. Where such a release is used it will be appreciated that if the electrical connection (to the remainder of the electric fence system) for energising the movable demarcation element was provided on the same demarcation vehicle as the release, then the release actuation has the inherent act of decoupling the movable demarcation element from the rest of the electric fence (i.e. the energy to movable demarcation element is removed when the release mechanism releases it).

In another approach, where the demarcation vehicle has a drum mechanism of the type generally described above for tensioning the demarcation element, the step of releasing the demarcation element may comprise operating the drum to reduce the tension in the demarcation element. This allows the demarcation element to fall to the ground which in turn allows the grazing animals to progress over the demarcation element and gain access to fresh grazing. Where this approach is employed, it will be appreciated that it desirable to de-activate the movable demarcation element prior to reducing the tension, so that the electric fence system as a whole is not inadvertently shorted to ground.

It will be appreciated that the various features described herein need not be combined as shown and indeed that several of the features may be employed to advantage in other configurations and systems. As an example, for the purposes of illustration, the drum feature for tensioning the demarcation element or the local switch module for activating/de-activating the electric fence may be provided on an entirely different demarcation vehicle, for example one that is configured to move along the ground as the advantages are useful in such ground-based vehicles as well. It will be appreciated that certain modifications may be required to accommodate these but that these would be relatively routine. For example, a movable connection (e.g. a bus arm) would be required to make an electrical connection to the fixed electric fence to provide a feed to the local switch module to activate/de-activate the movable demarcation element. The movable connection may itself form part of the switch module, e.g. the bus arm is the switching element. Similarly, for the drum tensioning element, the drum may be located lower down on the base of the demarcation vehicle with an arm used to support the movable demarcation element at a suitable height.

Similarly, it will be understood that the system of the present application is ideally suited to cattle but is not so restricted and may be used with other grazing animals.

Similarly, whilst the present application is of use in demarcation systems where the side demarcation elements along which the demarcation vehicles are made from wire (e.g. high tensile steel wire), they are equally applicable where the demarcation element is a steel rope or tape. It will be appreciated that the wheels may be varied to account for the size and type of demarcation element in use.

1-53. (canceled)

54. A device for moving along a first demarcation element in a pasture, the device comprising:
a first wheel for engaging with and being movable along a longitudinal axis of the first demarcation element;
a second wheel coupled to body and positioned to be aligned with the first wheel along the longitudinal axis;
an actuator mechanically coupled to and for causing rotation of the first wheel to cause the device to move along the first demarcation element and wherein the second wheel is mechanically coupled to an actuator for causing the second wheel to rotate to effect movement of the second wheel along the wire of the fence;
a body connected to and supported by the first wheel, where the body and first wheel are free to rotate about the longitudinal axis of the first demarcation element;
a receiver coupled to the body and provided on the opposite side of the longitudinal axis to the first wheel, the receiver being configured to receive an end of a second demarcation element.

55. A device according claim 54, wherein the first wheel and second wheel are substantially co-planar with the point where the receiver receives the end of the first demarcation element.

56. A device according to claim 54, wherein there is a single actuator for rotating the first and second wheels.

57. A device according to claim 56, wherein the actuator is an electric motor and further comprising a battery power supply for powering the electric motor.

58. A device according to claim 54, wherein an inner peripheral surface of the first wheel is shaped to receive and grip the first demarcation element, and wherein the inner peripheral surface defines a channel having two side walls for receiving the first demarcation element.

59. A device according to claim 58, wherein the side walls taper inwards at an angle toward the centre of the wheel to provide a friction fit with the first demarcation element.

60. A device according to claim 58, further comprising an outer peripheral surface, wherein the outer peripheral surface is shaped to receive and pass along an insulator on the first demarcation element.

61. A device according claim 54, wherein the first and second wheels are the same size and shape.

62. A device according to claim 54, further comprising a guide wheel which is positioned on the opposite side of the longitudinal axis to the first and second wheels wherein the guide wheel acts to prevent movement of the device in a direction transverse to the longitudinal axis toward the first and second wheels.

63. A device according to claim 62, wherein the guide wheel is free to move relative to the body in a direction transverse to the longitudinal axis and is resiliently biased toward the longitudinal axis.

64. A device according to claim 54, wherein the receiver comprises a reel provided on the body and having a drum around which the end of a second demarcation element may be wound.

65. A device according to claim 64, further comprising a reel actuator for causing the reel to wind the drum.

66. A device according to claim 65, further comprising a sensing arrangement for sensing the tension in the second demarcation element, wherein the device is configured to respond to the sensed tension to operate the reel motor to cause the second demarcation element to be payed out from or retrieved onto the reel to maintain the tension of the second demarcation element within a pre-determined range.

67. A device according to claim 54, further comprising a controller for operating the device, wherein the controller is provided on the device, wherein the controller is configured to receive a first position at the time the device is provided onto the first demarcation element and configured to store this position as the current device position, and the device further comprises an encoder for providing a measure of distance moved along the first demarcation element, wherein the controller is configured to update the first position by the measure of distance moved to provide a current position for the device along the first demarcation element.

68. A device according to claim 54, further comprising a post detector for detecting a post along the first demarcation element and for updating the current position of the device based on a previously stored position for the post.

69. A device according to claim 54, wherein the controller is configured to operate the actuator so that the device moves in steps.

70. A device according to claim 69, wherein the device comprises a communications device and the controller is configured to communicate using said communications device and wherein the controller is configured to receive a schedule for operation of the device via the communications device and wherein the controller is configured to move the device in accordance with the received schedule.

71. A device according to claim 70, wherein the device comprises a communications device and the controller is configured to communicate using said communications device wherein the communications device is configured to communicate with an electric fence controller over the single demarcation element and wherein the device is configured to send a signal to cause the electric fence controller to reduce or increase the voltage outputted by the electric fence controller or is configured to send a signal to turn-on or turn off the voltage outputted by the electric fence controller.

72. A device according to claim 54, further providing a switchable electric connection between the first demarcation element and a second demarcation element to allow an electric field present on the first demarcation to be switchably connected to the second demarcation element.

73. A device according to claim 54, wherein the device further comprises a camera, wherein the camera is positioned to capture an image of the pasture from the device along the second demarcation element.
